(19) United States
(12) Patent Application Publication
(10) Pub. No.: US 2006/0032839 A1
(43) Pub. Date: Feb. 16, 2006

(54) Device for welding by means of laser radiation

(76) Inventors: Gabriele Eberhardt, Jena (DE); Hans-Ulrich Zuehlke, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/529,930

(22) PCT Filed: Sep. 10, 2003
(86) PCT No.: PCT/DE03/03026

§ 371 Date: Apr. 1, 2005

(30) Foreign Application Priority Data
Oct. 1, 2002 (DE) 102 46 198.8

(51) Int. Cl. B23K 26/24; B23K 26/06

(52) U.S. Cl. 219/121.63; 219/121.75

(57) ABSTRACT

The invention is directed to a device by which two plastic parts can be welded together along their contacting joining surfaces (workpiece) quasi-simultaneously by laser radiation along a joining contour. The beam bundle emitted by a laser diode is coupled into a first gradient index lens by a light-conducting fiber. The first gradient index lens concentrates the beam bundle on a workpiece surface, this first gradient index lens being deflected relative to the exit surface of the light-conducting fiber so that the beam bundle scans a joining contour on the workpiece surface in order to heat, plasticize and weld the workpiece quasi-simultaneously. A plurality of such devices may be put together to form a more complex device in order to apply radiation to larger joining contours simultaneously and quasi-simultaneously.

### CROSS-REFERENCE TO RELATED APPLICATIONS

This application claims priority of International Application No. PCT/DE2003/003026, filed Sep. 10, 2003 and German Application No. 102 46 198.8, filed Oct. 1, 2002, the complete disclosures of which are hereby incorporated by reference.

### BACKGROUND OF THE INVENTION

a) Field of the Invention

The invention is directed to a device for quasi-simultaneous welding of two plastic parts along a joining contour by means of laser radiation.

b) Description of the Related Art

By joining contour is meant, within the meaning of the invention, the geometry of the welding between the joining surfaces of the parts (workpiece) to be welded. In principle, the joining contour can be punctiform, line-shaped or planar and may lie in three-dimensional space or only in a plane. Depending upon the parts to be welded, their extension may vary within a range of only a few millimeters to several meters.

By quasi-simultaneous welding is meant that the joining surfaces in the area of the joining contour are heated, plasticized and welded together with placement path virtually simultaneously in that an energy beam repeatedly sweeps over the joining contour before the melting of the two plastic parts to be welded. In simultaneous welding, the entire joining contour is acted upon by energy simultaneously.

The suitability of the generic devices known from the prior art to weld the joining contours to be joined with an appropriate expenditure on time and mechanical apparatus varies depending on the joining contour and its size in particular.

Devices known from the prior art for welding extended joining contours comprise, in addition to a laser radiation source, a scanning device which basically comprises at least a beam-shaping optical element and a beam-deflecting optical element. The object of the beam-shaping element is to concentrate the beam bundle on the workpiece surface. The beam bundle is guided over the workpiece surface in one dimension or two dimensions by means of the beam-deflecting elements which are connected to a drive unit.

Conventional collective lenses or lens arrangements with collective action are used as beam-shaping optical elements.

Polygon mirrors, galvanometer mirrors and prisms which are driven in an oscillating or rotating manner are used in particular as beam-deflecting optical elements. Devices of this kind, in which the scanning device is arranged at a fixed distance from the workpiece surface, can only scan limited areas of the workpiece surface, i.e., only joining contours whose size is smaller than the scanning area can be produced.

If the joining contour is only punctiform, the driven beam-deflecting elements can basically be dispensed with. The beam-deflecting elements are also not necessary when the joining contour is a line and the light source is projected on the workpiece surface as a line, e.g., by means of a cylindrical lens, in order to weld the workpiece simultaneously.

In order to produce extended joining contours, the beam bundle is normally directed to the workpiece surface by an articulated mirror arm that is guided by a robot arm. Therefore, a simultaneous or quasi-simultaneous welding of the entire joining contour is impossible.

Combinations of articulated mirror arms and scanning devices are also known. The scanning movement can be a superimposed movement of the beam-deflecting elements of the scanning device and of the robot arm or a movement exclusively of the beam-deflecting elements of the device by which adjacent scanning areas are scanned, the device being successively positioned relative to these adjacent scanning areas by the robot arm. Simultaneous or quasi-simultaneous welding of the entire joining contour is also impossible with a solution of this kind.

The devices known from the prior art for quasi-simultaneous welding comprising beam-shaping and beam-deflecting elements are uneconomical with respect to apparatus and design and generally have a large space requirement. Therefore, they are not suited to be arranged next to one another for welding a larger joining contour quasi-simultaneously by simultaneous scanning of adjacent partial joining contours.

Known devices for simultaneous welding take up less space because they do not require a mechanism for generating relative movement. However, they do require extensive adjustment if they are to be arranged next to one another so as to make up a more complex apparatus in order to weld a larger joining contour comprising a plurality of partial joining surfaces. Faulty adjustments result in overlapping areas receiving twice the amount of radiation or in areas of the joining surface that are not welded.

### OBJECT AND SUMMARY OF THE INVENTION

It is the primary object of the invention to provide a device for the quasi-simultaneous welding of joining contours or partial joining contours which can be produced economically with respect to apparatus and design, has an appreciably reduced space requirement and, when a plurality of such devices are arranged next to one another, is suitable for the simultaneous welding of a plurality of partial joining contours forming a larger closed joining contour.

According to the invention, this object is met by a device for welding a joining contour by laser radiation comprising a laser diode and a light-conducting fiber which is arranged in front with reference to the radiating direction of the laser diode, the beam bundle emitted by the laser diode being coupled into an entrance surface of the light-conducting fiber and an exit surface of the light-conducting fiber being arranged in front of a beam-shaping optical unit with reference to the direction of radiation so that the beam bundle images a focal spot, by way of the beam-shaping optical unit, on a workpiece surface arranged downstream of the beam-shaping optical unit. The beam-shaping optical unit comprising at least one gradient index lens which is connected to at least one linear movement unit by which the gradient index lens is deflected radial to the exit surface by a displacement path in order to generate a deflection of the beam bundle so that the focal spot scans a joining contour on the workpiece surface.

An essential idea of the invention consists in that a gradient index lens, such as is used in many areas of technology as a fiber coupling, is employed as beam-shaping optical element. Instead of beam-deflecting elements such as those used in the prior art to guide the beam bundle over the workpiece surface, the gradient index lens is moved relative to the exit surface of the light-conducting fiber and is constructed in such a way that even a slight deflection (displacement path) of the gradient index lens relative to the light-conducting fiber is sufficient to generate a large deflection (welding path) of the beam bundle on the workpiece surface. The required relative movement between the gradient index lens and the exit surface of the light-conducting fiber can also be realized by deflection of the light-conducting fiber or by a combined movement of the light-conducting fiber and gradient index lens instead of by the gradient index lens.

A device according to the invention whose size and external dimensions are determined substantially by the movement unit can be constructed so as to be substantially smaller and lighter than conventional devices for simultaneous welding by means of laser. In particular, this has the advantage that a plurality of devices of this kind can be adjacent to one another to form a more complex apparatus in order to weld larger joining contours.

The invention will be described more fully in the following with reference to several embodiment examples shown in the drawings.

### BRIEF DESCRIPTION OF THE DRAWINGS

In the drawings:

FIG. 1 shows a schematic arrangement for a device with a gradient index lens and a movement unit;

FIG. 2 shows a schematic arrangement for a device with a gradient index lens and two movement units;

FIG. 3 shows a schematic arrangement for a device with two gradient index lenses;

FIG. 4 shows the construction of an open device; and

FIG. 5 is a perspective view of a subassembly of a device according to FIG. 4.

### DESCRIPTION OF THE PREFERRED EMBODIMENTS

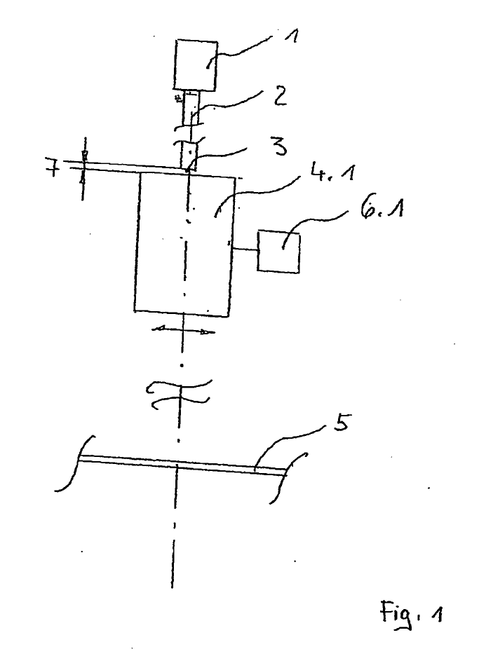

FIG. 1 shows a first embodiment example for a device according to the invention. With respect to its technical apparatus, it comprises a laser diode 1, a light-conducting fiber 2, a first gradient index lens 4.1, a first piezo actuator 6.1, and a workpiece holder, not shown, in which the parts (hereinafter workpiece) to be welded are held. The radiation emitted from the laser diode 1 is coupled directly into the light-conducting fiber 2. The exit surface 3 of the light-conducting fiber 2 is fixed at a defined working distance 7 from the first gradient index lens 4.1. The exit surface 3 and a first plane surface of the first gradient index lens 4.1 lie in planes that are parallel to one another also during their relative movement with respect to one another. When not in a deflected position, the surface center of the exit surface 3 lies on the optical axis of the first gradient index lens 4.1. The first gradient index lens 4.1 is constructed in such a way that its object plane lies in the plane of the exit surface 3. The working distance 7 is as small as possible, less than 0.3 mm, so that the diameter of the circle of confusion of the beam bundle impinging on the first plane surface, which is determined by the aperture of the light-conducting fiber 2, is appreciably smaller than the diameter of the first gradient index lens 4.1. This size ratio determines the possible movement range, that is, the first gradient index lens 4.1 and the exit surface 3 can be displaced relative to one another only to the extent that the circle of confusion still completely strikes the first plane surface of the first gradient index lens 4.1. For this reason, the effort is made to use a light-conducting fiber 2 with the smallest possible cross section, although this is limited in turn by the minimum beam output needed for welding. Suitable fiber diameters are currently in the range of 50 μm to 1000 μm. The diameter of the gradient index lenses 4.1, 4.2 is between 0.5 mm and 2 mm.

Further, the first gradient index lens 4.1 is constructed in such a way that it images the exit surface 3 on the workpiece surface 5 with a large imaging scale. The greater the imaging scale, the smaller the deflection path (adjustment path) by which the first gradient index lens 4.1 must be deflected in order to cause a large deflection (welding path) of the beam bundle on the workpiece surface 5.

In order to deflect the first gradient index lens 4.1 relative to the exit surface 3, it is connected to the first piezo actuator 6.1 which moves the first gradient index lens 4.1 back and forth within its possible adjustment path at a frequency of up to 100 Hz or can guide it into various positions along the displacement path, i.e., static and dynamic positioning is possible within the full range of the displacement path.

A displacement path (amplitude) of less than 500 μm is sufficient to generate lines up to a length of 20 mm when, e.g., a light-conducting fiber 2 with a diameter of 50 μm is increased forty-fold. In this regard, a particular advantage over a conventional collective lens is that the far-axis images do not have such extensive distortion, i.e., the focal spot of about 2 mm formed on the workpiece surface 5 remains constant in diameter on the generated line.

A focal spot size of about 1 mm is more favorable for the input of energy into the workpiece. This is achieved, for example, for a light-conducting fiber 2 with a diameter of 50 μm at a magnification of 20 and a displacement path of about 1500 μm. The welding path can then be up to 30 mm, i.e., the joining contour can be up to 30 mm×30 mm.

A device according to the first embodiment example is particularly suitable for carrying out spot welding along a straight line of less than 30 mm or for carrying out a weld seam with a joining contour equal to a straight line of less than 30 mm.

In contrast to the first embodiment example, a second embodiment example, not shown in the drawings, has an additional adjusting device 9. In order to vary the diameter of the focal spot, the workpiece distance 8 (distance between the workpiece surface 5 when the first gradient index lens 4.1 is not deflected and the second plane surface of the first gradient index lens 4.1) can be changed by means of the adjusting device 9 so that the exit surface 3 is imaged out of focus on the workpiece surface 5. This adjusting device 9 is also useful when the workpiece surface 5 has no plane surface. The adjusting device 9 then provides for a constant workpiece distance 8. However, insofar as the deviations of the workpiece surface 5 from a plane lie within the depth of focus range, it is not necessary to readjust the workpiece distance 8.

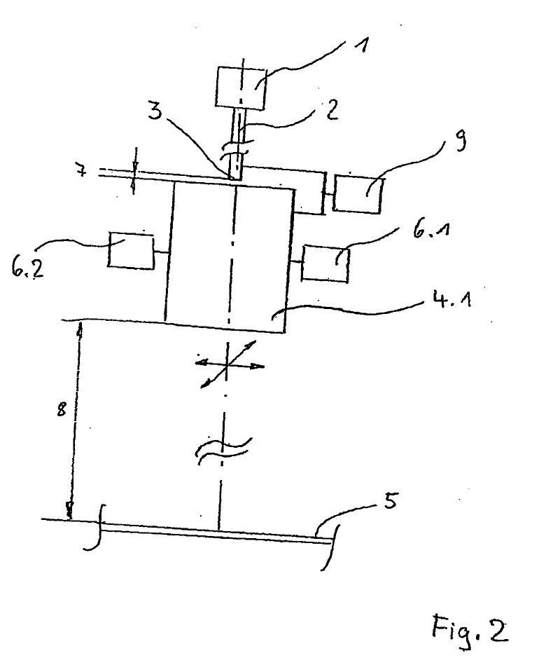

FIG. 2 shows a third embodiment example. This differs from the second embodiment example in that a second piezo actuator 6.2 is provided in addition. This second piezo actuator 6.2 likewise acts on the first gradient index lens 4.1 and allows it to be deflected in perpendicular direction relative to the deflection direction of the first piezo actuator 6.1. By superimposing the two deflecting movements, a line of any shape can be generated or a surface can be scanned.

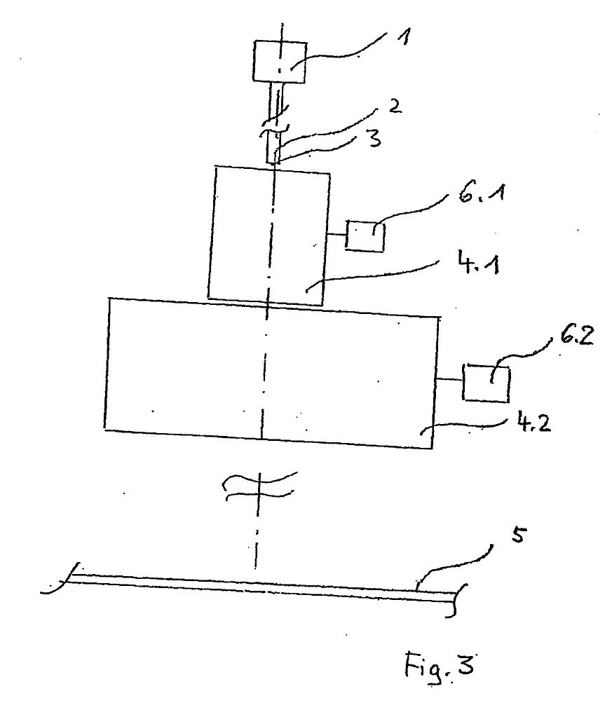

In a fourth embodiment example shown in FIG. 3, a first and a second gradient index lens 4.1, 4.2 are used instead of only a first gradient index lens 4.1. Optically, the two gradient index lenses 4.1, 4.2 perform the same function as a first gradient index lens 4.1, shown in embodiment examples 1 to 3, by itself. Purely in terms of design, however, it may be simpler when there are not two piezo actuators 6.1, 6.2 acting on a first gradient index lens 4.1, which proves difficult because of its small dimensions. Also, additional steps must be taken so that the first piezo actuator 6.1 can follow a deflection caused by the second piezo actuator 6.2, and vice versa. On the other hand, when two gradient index lenses 4.1, 4.2 are used, they must be constructed in such a way that the beam bundle exiting from the first gradient index lens 4.1 and entering the second gradient index lens 4.2 is not masked in any possible position of the two gradient index lenses 4.1, 4.2.

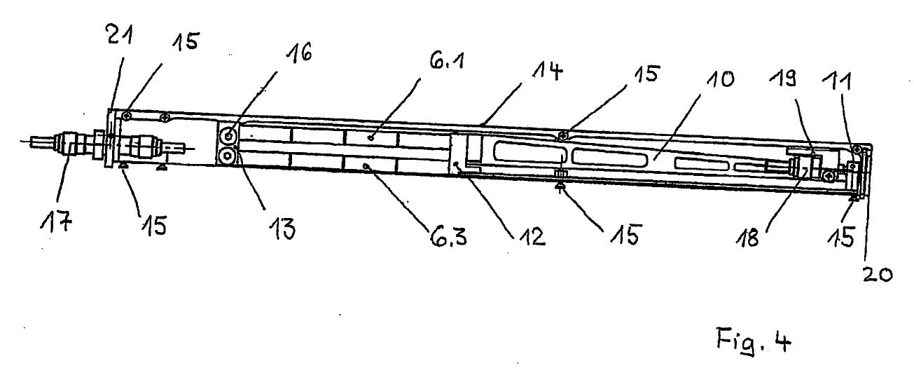

A specific construction for a device according to the invention is described in a fifth embodiment example. FIG. 4 shows a top view of a device which is open on two sides and in which, for the sake of simplicity, the light-conducting fiber 2, the electric lines to the piezo actuators 6.1, 6.2, and the laser diode 1 are not shown.

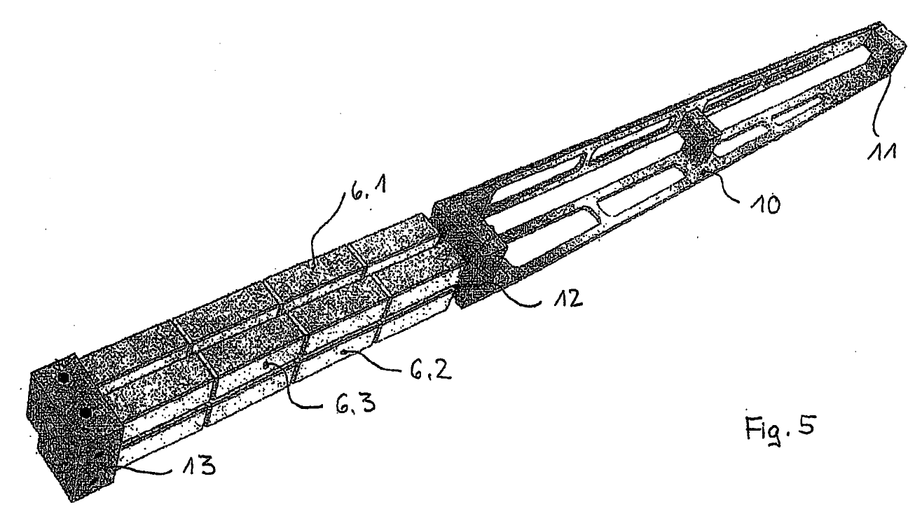

FIG. 5 shows a perspective view of an arm 10, which is terminated by the end plate 11 and the bearing plate 12, in connection with the piezo actuators 6.1, 6.2. In combination with the first gradient index lens 4.1, this subassembly represents the core of the invention.

Three piezo actuators 6.1, 6.2 of identical construction are fixedly connected by one end on a base plate 13 parallel to one another accompanied by pretensioning, while the second end of the piezo actuators 6.1, 6.2, respectively, is connected to the bearing plate 12 which is oriented parallel to the base plate 13 in the inactive state. The third piezo actuator 6.3 only functions as a spacer with a thermal coefficient of expansion equal to that of the acting piezo actuator 6.1, 6.2. The connection of the second end of the third piezo actuator 6.3 to the bearing plate 12 is formed by a pivot joint that defines a pivot point around which the bearing plate 12 is swiveled when the piezo actuators 6.1, 6.2 are activated. The deflection of the bearing plate 12 is determined by the actuating path of the piezo actuators 6.1 and 6.2 contacting the bearing plate 12 by their second ends. The bearing plate 12 is a terminating part of an arm 10. The length of the arm 10 is determined by the desired distance that must exist between the end plate 11, which forms a second terminating part of the arm 10 and to which the second gradient index lens 4.2 is fixed, and the bearing plate 12 in order for the actuating path of the piezo actuators 6.1, 6.2 to result in displacement paths of desired length for the first gradient index lens 4.1. At a total length of the arm 10 of, e.g., about 15 cm, an actuating path of 50 μm can be multiplied to a displacement path of 1.5 mm. The arm 10 itself must be rigid, torsion-resistant and as light as possible.

Two housing angles 14 which enclose the subassembly described above are fastened to the circumference of the base plate 13 by connection elements 16. A first housing angle 14 is shown in FIG. 4. The second housing angle which is connected to the first housing angle 14 by screws 15 is not shown in the drawing so that the internal structural component parts can be shown. The tubular housing formed by the housing angles is closed at one end directly below the end plate 11 by an end glass 20. The other end projects beyond the base plate 13 and is closed by a cover plate 21. The cover plate 21, like the base plate 13, has openings through which power lines, not shown in the drawing, are guided into the interior of the housing to the piezo actuators 6.1, 6.2. Further, a fiber coupling 17 is guided through the cover plate 21 and is fixedly connected to the latter. The fiber coupling 17 serves on the one hand to hold the light-conducting fiber 2, not shown in FIG. 4, in order to position it relative to the housing and, on the other hand, makes it possible for the light-conducting fiber 2 to be realized in practice by two lengths of fiber, namely, a length of fiber which extends within the housing and a length of fiber which is located outside the housing and into which the beam of the laser diode 1 is coupled. The free end of the light-conducting fiber 2 located in the housing is held in a fiber connector 18 directly above the first gradient index lens 4.1 which is rigidly connected to the housing by a fiber connector holder 19. When the piezo actuators 6.1, 6.2 are actuated, the first gradient index lens 4.1 is displaced (swiveled) below the exit surface 3 of the light-conducting fiber 2.

With a light-conducting fiber 2 having a diameter of 100 μm, a working distance 7 between the exit surface 3 and entrance surface of the first gradient index lens 4.1 of 100 μm, a lens diameter of 1.8 mm, and a lens magnification of 14, welding paths of 20 mm can be realized, i.e., a joining contour of 20 mm×20 mm can be welded quasi-simultaneously.

It is particularly advantageous that the device does not exceed the dimensions of the weldable joining contour parallel to the workpiece surface 5, so that the devices can easily be arranged in series for simultaneous welding of closed, larger joining contours.

In a sixth embodiment form, not shown in the drawing, a device comprises a plurality of devices as was shown in embodiment examples 1 to 5. Common to all of the embodiment examples 1 to 5 is that a joining contour whose dimensions are determined by the deflection area that can be traversed by the beam bundle on the workpiece surface 5 can be generated quasi-simultaneously. The advantage of the invention becomes especially clear in this connection. Because of the small space requirement which is determined essentially only by the piezo actuators 6.1, 6.2, a plurality of modules can be arranged close together and are adapted to one another with respect to function so as to jointly, simultaneously generate a larger joining contour made up of individual partial joining contours. The entire joining contour is acted upon by the beam in that all of the modules sweep over a partial joining contour simultaneously; i.e., the workpiece comprising two parts whose joining surfaces contact one another is heated, plasticized and welded in the area of the joining contour simultaneously and quasi-simultaneously.

In all of the embodiment examples described above, it was assumed that the beam-shaping optical unit comprising one or two gradient index lenses 4.1, 4.2 images the exit surface 3 of the light-conducting fiber 2 on the workpiece surface 5. The gradient index lenses 4.1, 4.2 can also be dimensioned in such a way and arranged relative to the exit surface 3 such that the beam bundle is collimated and focused on the workpiece surface 5.

Instead of the piezo actuators 6.1, 6.2, other linear movement units known from the prior art such as capacitive actuators or electromagnetic actuators can also be used.

It is self-evident that the device according to the invention can also be applied in combination with robot arms. Compared to conventional devices of the same type, its low weight is a chief advantage.

Spot welds can also be generated simultaneously at a fixed distance from one another with the same number of devices positioned relative to one another that is used for generating weld spots. Devices of this kind do not require linear movement units.

While the foregoing description and drawings represent the present invention, it will be obvious to those skilled in the art that various changes may be made therein without departing from the true spirit and scope of the present invention.

### REFERENCE NUMBERS

1 laser diode
2 light-conducting fiber
3 exit surface
4.1 first gradient index lens
4.2 second gradient index lens
5 workpiece surface
6.1 first piezo actuator
6.2 second piezo actuator
6.3 third piezo actuator
7 working distance
8 workpiece distance
9 adjusting device
10 arm
11 end plate of the arm
12 bearing plate of the arm
13 base plate
14 first housing angle
15 screws for connecting the housing angles
16 connection elements
17 fiber coupling
18 fiber connector
19 fiber connector holder
20 end glass
21 cover plate

1-9. (canceled)

10. A device for welding a joining contour by laser radiation, comprising:
a laser diode;
a light-conducting fiber which is arranged in front with reference to the radiating direction of the laser diode, the beam bundle emitted by the laser diode being coupled into an entrance surface of the light-conducting fiber and an exit surface of the light-conducting fiber being arranged in front of a beam-shaping optical unit with reference to the direction of radiation so that the beam bundle images a focal spot, by way of the beam-shaping optical unit, on a workpiece surface arranged downstream of the beam-shaping optical unit;
said beam-shaping optical unit comprising at least one gradient index lens which is connected to at least one linear movement unit by which the gradient index lens is deflected radial to the exit surface by a displacement path in order to generate a deflection of the beam bundle so that the focal spot scans a joining contour on the workpiece surface.

11. The device according to claim 10, wherein the beam-shaping optical unit comprises exactly one (the first) gradient index lens which is connected to two linear movement units provided by a first and a second piezo actuator 6.1, 6.2 which cause a deflection of the first gradient index lens in directions perpendicular to one another.

12. The device according to claim 10, wherein the beam-shaping optical unit comprises exactly two gradient index lenses which are arranged one behind the other with reference to the direction of radiation and which are connected, respectively, to a linear movement unit provided by a first and a second piezo actuator in order to deflect in directions perpendicular to one another with respect to the exit surface.

13. The device according to claim 10, wherein the beam-shaping optical unit is constructed in such a way that the exit surface is arranged at a distance of less than 0.3 mm in front of the first optical surface and the workpiece surface is arranged at a distance of greater than 10 mm behind the final optical surface of the beam-shaping optical unit, and the beam-shaping optical unit has an imaging scale of greater than 30.

14. The device according to claim 11, wherein the beam-shaping optical unit is constructed in such a way that the exit surface lies in its object plane and the workpiece surface lies in the image plane in the undeflected state, and the beam-shaping unit has a depth of focus range that is greater than a maximum change in distance of a non-plane workpiece surface over the range of deflection relative to the final optical surface of the beam-shaping optical unit.

15. The device according to claim 11, wherein the first piezo actuator and the second piezo actuator are connected to the first gradient index lens directly by an arm which translates the actuating path of the piezo actuators into the displacement paths of the first gradient index lens.

16. The device according to claim 15, wherein the piezo actuators are fixedly attached, respectively, by one end to a base plate and contact a bearing plate of the arm, respectively, by their free end, and the bearing plate is swivelable around a pivot point that is fixed with respect to the base plate so that when the piezo actuators are activated the bearing plate and, therefore, the arm are swiveled around the pivot point corresponding to their actuating paths.

17. The device according to claim 16, wherein the pivot point is defined by a pivot joint which is located at one end of a third piezo actuator that determines the distance of the pivot point from the base plate parallel to the piezo actuators.

18. The device for welding a joining contour by laser radiation, wherein it comprises a plurality of devices according to claim 10 which are arranged relative to one another in such a way that the respective scanned joining contours correspond to partial joining contours which combine to form a larger closed joining contour without overlapping of the partial joining contours.
